(19) United States
(12) Patent Application Publication
(10) Pub. No.: US 2018/0259777 A1
(43) Pub. Date: Sep. 13, 2018

(54) EYEPIECE PROJECTION OPTICAL APPARATUS

(71) Applicant: OLYMPUS CORPORATION, Tokyo (JP)

(72) Inventor: Ryosuke UEMURA, Tokyo (JP)

(73) Assignee: OLYMPUS CORPORATION, Tokyo (JP)

(21) Appl. No.: 15/978,770

(22) Filed: May 14, 2018

Related U.S. Application Data
(63) Continuation of application No. PCT/JP2015/085826, filed on Dec. 22, 2015.

(51) Int. Cl. G02B 27/01; G02B 5/04

(52) U.S. Cl. CPC G02B 27/0172; G02B 17/086; G02B 2027/0178; G02B 5/04

(57) ABSTRACT

The eyepiece projection optical apparatus (1) includes a display device (20), and a prism optical system (10) having three internal reflections in an effective optical path. The prism optical system (10) is configured mirror-symmetrically with respect to one plane of symmetry (Y-Z plane) in an effective optical path, and includes an incident surface (15), a first reflecting surface (14), a third reflecting surface (12), and a combined reflecting and exit surface (11, 13) where one area of the second reflecting surface (13) overlaps with one area of the exit surface (11), with satisfaction of the following condition: 0.05<Mmin/L<0.23.

### CROSS-REFERENCE TO RELATED APPLICATIONS

This application is based on PCT/JP2015/085826 filed on Dec. 22, 2015. The content of the PCT application is incorporated herein by reference.

### BACKGROUND OF THE INVENTION AND RELATED ART STATEMENT

The present invention relates generally to an eyepiece projection optical apparatus designed to guide an image shown on a display device into a viewer's eyeball where it is enlarged as a virtual image for projection.

In recent years, there has been a rapid-paced advance of the wearable display technology adapted to guide images shown on a display device into the viewer's eyeballs where they are enlarged as virtual images for projection (JP(A) 2015-106146).

### SUMMARY OF INVENTION

An eyepiece projection optical apparatus has

a display device including a display screen for showing an image, and

an eyepiece projection optical system that guides the image shown on the display screen, with no formation of any intermediate image, into a viewer's eyeball where it is enlarged as a virtual image for projection, wherein the eyepiece projection optical system includes a prism that is capable of three internal reflections in an effective optical path and filled up with a medium having a refractive index higher than that of an ambient medium, wherein the prism is configured mirror-symmetrically with respect to one plane of symmetry in an effective optical path and includes an incident surface on which a light beam is incident, a first reflecting surface that reflects the light beam incident from the incident surface, a third reflecting surface that reflects a light beam toward an exit side and has a concave surface shape, a second reflecting surface that is located in opposition to the first reflecting surface and third reflecting surface and reflects a light beam reflected off the first reflecting surface toward the third reflecting surface, and an exit surface through which the light reflected off the third reflecting surface exits out, and further includes a combined reflecting and exit surface where one area of the second reflecting surface overlaps with one area of the exit surface, with satisfaction of the following condition (1):

0.05<Mmin/L<0.23 (1)

where L is a distance on the plane of symmetry from a center point P of the display screen to a prism contour end Q that is farthest away from the center point P, and Mmin is the minimum of distances on the plane of symmetry between two points where a straight line orthogonal to a segment PQ intersects surfaces inclusive of the combined reflecting and exit surface and the first reflecting surface of the prism.

### BRIEF DESCRIPTION OF DRAWINGS

FIG. 1 is illustrative in arrangement of the eyepiece projection optical apparatus according to one embodiment.

FIG. 2 is illustrative in X-Z sectional arrangement in of the eyepiece projection optical apparatus according to one embodiment.

FIG. 3 shows a chamfered or beveled portion of the prism optical system according to one embodiment.

FIG. 4 is illustrative of the prism optical system and display screen in the eyepiece projection optical apparatus according to one embodiment.

FIG. 5 is an optical path diagram taken in the Y-Z section of the eyepiece projection optical apparatus according to Example 1 of one embodiment.

FIG. 6 is an optical path diagram taken in the X-Z section of the eyepiece projection optical apparatus according to Example 1 of one embodiment.

FIG. 7 is an optical path diagram taken in the Y-Z section of the eyepiece projection optical apparatus according to Example 2 of one embodiment.

FIG. 8 is an optical path diagram taken in the X-Z section of the eyepiece projection optical apparatus according to Example 2 of one embodiment.

FIG. 9 is an optical path diagram taken in the Y-Z section of the eyepiece projection optical apparatus according to Example 3 of one embodiment.

FIG. 10 is an optical path diagram taken in the X-Z section of the eyepiece projection optical apparatus according to Example 3 of one embodiment.

FIG. 11 is an optical path diagram taken in the Y-Z section of the eyepiece projection optical apparatus according to Example 4 of one embodiment.

FIG. 12 is an optical path diagram taken in the X-Z section of the eyepiece projection optical apparatus according to Example 4 of one embodiment.

FIG. 13 shows one basic configuration of an image display apparatus that incorporates the eyepiece projection optical apparatus.

FIG. 14 is a side view of the image display apparatus that incorporates the eyepiece projection optical apparatus.

FIG. 15 is a side view of another image display apparatus that incorporates the eyepiece projection optical apparatus.

FIG. 16 shows a head-mounted image display apparatus that incorporates the eyepiece projection optical apparatus.

FIG. 17 is a front view of the head-mounted image display apparatus that incorporates the eyepiece projection optical apparatus.

### DESCRIPTION OF EMBODIMENTS

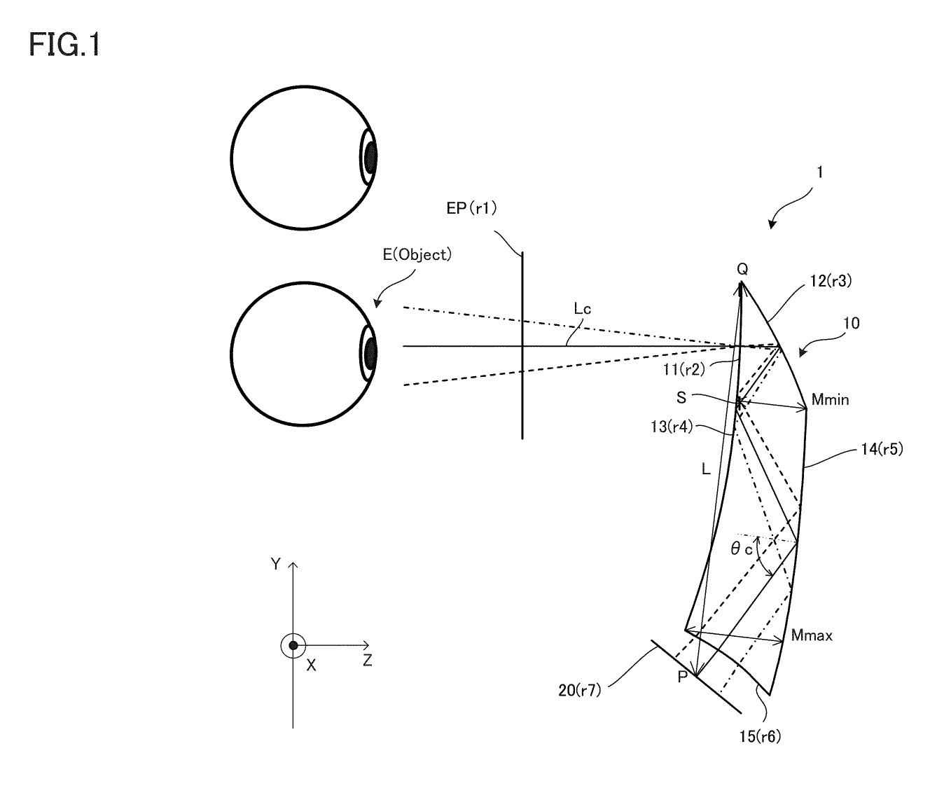

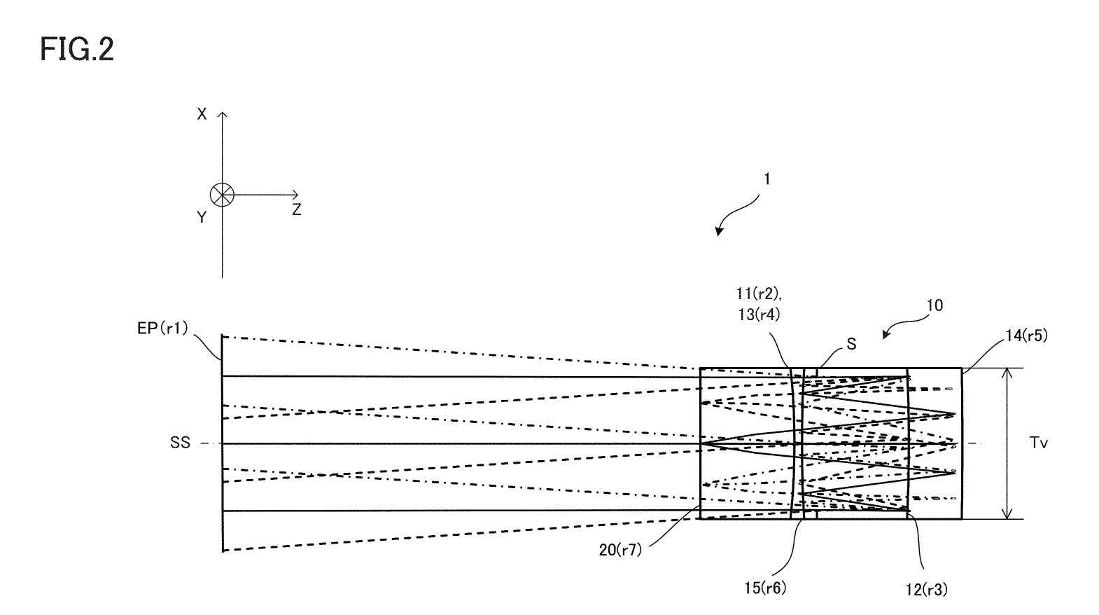

FIG. 1 is illustrative in arrangement of the eyepiece projection optical apparatus 1 according to one embodiment, and FIG. 2 is illustrative in X-Z sectional arrangement of the eyepiece projection optical apparatus 1 according to one embodiment.

The eyepiece projection optical apparatus 1 according to one embodiment includes a display device 20 including a display screen for showing an image, and a prism optical system 10 that guides that image into a viewer's eyeball with no formation of any intermediate image, where it is enlarged as a virtual image for projection. Upon viewing, it is preferable that the eyepiece projection optical apparatus 1 is mounted on the viewer's head such that the plane SS of symmetry of the prism optical system 10 remains substantially horizontal.

The prism optical system 10 according to this embodiment is configured mirror-symmetrically with respect to one plane of symmetry in an effective optical path, includes an incident surface 15 on which a light beam is incident, a first reflecting surface 14 that reflects a light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface where one area of the second reflecting surface 13 overlaps with one area of the exit surface 11, is capable of three internal reflections, and is filled up with a medium having a refractive index higher than that of an ambient medium.

Light exiting out from an image plane, i.e., the display screen of the image display device 20 according to this embodiment passes through the prism optical system 10, and enters the viewer's eyeball that lies near or in front of an eye point (EP) to form an enlarged virtual image. It is thus possible for the viewer to view the whole displayed image as a virtual image.

Here the coordinate system according to this embodiment is explained. The origin of the coordinate system (X=0, Y=0, and Z=0) is defined by the center of the pupil of a virtual viewer, and the Z-axis positive direction is defined by a direction of the prism optical system from the origin along a center chief ray. That center chief ray is defined by a light beam that exits out from the center of the display screen, then enters the prism optical system 10, is then subjected to three internal reflections, and then exits out from the prism optical system 10, arriving at the center of the viewer's pupil. The Y-axis positive direction is defined by a direction that is vertical to the Z-axis, parallel with the plane of symmetry SS and in opposition to the location of the display device 20. Accordingly, the plane of symmetry SS defines the Y-Z plane; the X-axis positive direction is defined by a direction that is vertical to the Y-Z plane and forms a left-handed system with the Y-axis and Z-axis.

The eyepiece projection optical apparatus according to one embodiment includes a display device 20 including a display screen for showing an image, and a prism optical system 10 that guides the image shown the display screen, with no formation of any intermediate image, into a viewer's eyeball where it is enlarged as a virtual image for projection. The prism optical system 10 is configured mirror-symmetrically with respect to one plane of symmetry SS in an effective optical path and includes an incident surface 15 on which a light beam is incident, a first reflecting surface 14 that reflects the light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface 11, 13 where one area of the second reflecting surface 13 overlaps with one area of the exit surface 11, with satisfaction of the following condition (1):

0.05<Mmin/L<0.23 (1)

where L is a distance on the plane of symmetry SS from a center point P of the display screen to a prism contour end Q that is farthest away from the center point P, and Mmin is the minimum of distances on the plane of symmetry SS where a straight line orthogonal to a segment PQ intersects the surfaces inclusive of the combined reflecting and exit surface 11, 13 and the first reflecting surface 14 of the prism optical system.

The prism optical system 10 used with the wearable display must be easy to view and of small size, and feel quite normal. This prism optical system 10 includes an incident surface 15 on which a light beam is incident, a first reflecting surface 14 that reflects the light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface where one area of the second reflecting surface 13 overlaps with one area of the exit surface 11. This surface configuration makes it possible to reduce the thickness of the prism optical system 10 in the line-of-sight direction while there is the surface size ensured that is necessary for taking hold of the viewing angle of view and viewable range (wherein the whole virtual image can be viewed through the pupil located in place).

There is also a mounting need to show a virtual image just in front of the face while allowing the viewer to view an outside image with ease and a third person to remain undisturbed by the viewer's line of sight upon taking a look at the virtual image. However, a physical distance between the exit surface 11 and the display device 20 must be kept long so as to prevent the display device 20 from cutting off the outside while the virtual image remains positioned near the front of the face. In this embodiment with a reduced number of internal reflections, spacing the display device 20 enough away from the exit surface 11 is contradictory to the prism 10 that must be of small size and have a large enough angle of view, i.e., the prism 10 that remains being low-profile with a relatively short focus length.

If the condition (1) is satisfied, however, it is then possible to assign the optical path shortened in the line-of-site direction to an optical path in a direction of making the display device 20 farther away from the exit surface 11. Even when the virtual image is displayed near the front of the viewer, it is unlikely that the outside may be cut off by the display device 20, making it possible to satisfy all the requirements at the same time.

Exceeding the upper limit value of Condition (1) is badly detrimental to design because the prism optical system 10 grows too thick in the line-of-sight direction or, otherwise, the longitudinal direction of the contour of the prism optical system 10 becomes too short, resulting in the outside being cut off by the display device. Falling short of the lower limit value of Condition (1) fails to get hold of any sufficient viewing angle of view or viewable range because the prism optical system 10 gets too thin in the line-of-sight direction.

Preferably, the following condition (1′) should be satisfied.

0.1<Mmin/L<0.21 (1′)

More preferably, the following condition (1″) should be satisfied.

0.12<Mmin/L<0.19 (1″)

Further, the eyepiece projection optical system 1 according to this embodiment satisfies the following condition (2):

2.0 mm<Mmin<10.0 mm (2)

By satisfaction of Condition (2), the thickness of the prism optical system 10 in the line-of-sight direction may be placed in the optimum balance. The thickness of the optical system 10, because of forming a forward protrusion, is important in view of use and design.

Exceeding the upper limit value of Condition (2) is badly detrimental to design because the prism optical system 10 grows too thick in the line-of-sight direction. Falling short of the lower limit value of Condition (2) fails to get hold of any sufficient viewing angle of view or viewable range because the prism optical system 10 gets too thin in the line-of-sight direction.

Preferably, the following condition (2′) should be satisfied:

2.5 mm<Mmin<8.0 mm (2′)

More preferably, the following condition (2″) should be satisfied:

3.0 mm<Mmin<6.5 mm (2″)

Furthermore, the eyepiece projection optical system 1 according to this embodiment satisfies the following condition (3):

1.5 mm<Tv<14.5 mm (3)

where Tv is the maximum width of the effective area of the third reflecting surface of the prism optical system 10 as measured in a direction vertical to the plane of symmetry SS.

By satisfaction of Condition (3), the thickness of the prism optical system 10 in the direction vertical to the plane of symmetry SS may be placed in the optimum balance.

Exceeding the upper limit value of Condition (3) causes the prism optical system 10 to grow unnecessarily thicker in the direction vertical to the plane of symmetry than expected by the aspect of the display device 20 that is ordinarily used. Falling short of the lower limit value of Condition (3) fails to get hold of any sufficient viewing angle of view and viewable range because the prism optical system 10 becomes too thin in the direction vertical to the plane of symmetry.

Preferably, the following condition (3′) should be satisfied:

1.5 mm<Tv<10 mm (3′)

More preferably, the following condition (3″) should be satisfied:

2.0 mm<Tv<4.5 mm (3″)

In the eyepiece projection optical apparatus 1 according to the embodiment described here, at least two surfaces of the incident surface 14, third reflecting surface 12, and combined reflecting and exit surface 11, 13 each has a rotationally asymmetric surface configured mirror-symmetrically with respect to the plane of symmetry SS.

The eyepiece projection optical apparatus 1 according to the embodiment described here, because of being a decentered optical system, must be corrected for decentration aberrations; so there are preferably at least two rotationally asymmetric surfaces provided for correction of such aberrations. However, it is noted that the eyepiece projection optical apparatus 1 is configured mirror-symmetrically with respect to a horizontal plane corresponding to the eye line; so the rotationally asymmetric surfaces too are configured mirror-symmetrically with respect to the corresponding horizontal plane.

In the eyepiece projection optical apparatus 1 according to the embodiment described here, at least two surfaces of the incident surface 15, first reflecting surface 14, third reflecting surface 12 and combined reflecting and exit surface 11, 13 each has a rotationally symmetric surface that is mirror-symmetric with respect to the plane of symmetry SS alone.

The eyepiece projection optical apparatus 1 according to the embodiment described here, because of being a decentered optical system, must be corrected for as much decentration aberrations as possible. To correct for such aberrations, there are preferably at least two rotationally asymmetric surfaces provided, each mirror-symmetric with respect to the plane of symmetry SS alone. However, it is noted that the eyepiece projection optical apparatus 1 is configured mirror-symmetrically with respect to a horizontal plane corresponding to the eye line; so the rotationally asymmetric surfaces too are configured mirror-symmetrically with respect to the corresponding horizontal plane.

In the eyepiece projection optical apparatus 1 according to the embodiment described here, the first reflecting surface 14, third reflecting surface 12 and combined reflecting and exit surface 11, 13 each has a rotationally asymmetric surface that is mirror symmetric with respect to the plane of symmetry SS.

The eyepiece projection optical apparatus 1 according to the embodiment described here, because of being a decentered optical system, must be corrected for decentration aberrations. For correction of such aberrations, there are preferably four rotationally asymmetric surfaces provided, each mirror symmetric with respect to the plane of symmetry SS. However, it is noted that the eyepiece projection optical apparatus 1 is configured mirror-symmetrically with respect to a horizontal plane corresponding to the eye line; so the rotationally asymmetric surfaces too are configured mirror-symmetrically with respect to the corresponding horizontal plane.

In the eyepiece projection optical apparatus 1 according to the embodiment described here, the first reflecting surface 14, third reflecting surface 12 and combined reflecting and exit surface 11, 13 each has a rotationally asymmetric surface having that is mirror-symmetric with respect to the plane of symmetry SS alone.

The eyepiece projection optical apparatus 1 according to the embodiment described here, because of taking the form of a decentered optical system, must be corrected for as much decentration aberrations as possible. To correct for such aberrations, there are preferably four rotationally asymmetric surfaces provided, each mirror-symmetric with respect to the plane of symmetry SS alone. However, it is noted that the eyepiece projection optical apparatus 1 is configured mirror-symmetrically with respect to a horizontal plane corresponding to the eye line; so the rotationally asymmetric surfaces too are configured mirror-symmetrically with respect to the corresponding horizontal plane.

In the eyepiece projection optical apparatus 1 according to the embodiment described here, the incident surface 15, first reflecting surface 14, third reflecting surface 12 and combined reflecting and exit surface 11, 13 each has a rotationally asymmetric surface that is mirror-symmetric with respect to the plane of symmetry SS.

In the eyepiece projection optical apparatus 1 according to the embodiment described here, the combined reflecting and exit surface 11, 13 has, on the plane of symmetry SS, a negative power in such a way as to be concave on the viewer's eyeball side.

Preferably, the combined reflecting and exit surface 11, 13 has a negative power in a horizontal sectional direction for the purpose of fitting well to the face configuration. It is preferable for the third reflecting surface 12 to have a positive power for the purpose of keeping the diameter of the luminous flux to be guided small in consideration of back ray tracing from the viewer side.

In the eyepiece projection optical apparatus 1 according to the embodiment described here, the first reflecting surface 14 has a positive power on the plane of symmetry in such a way as to have a concave shape on the viewer's eyeball side.

Imagine here that the prism optical system 10 is a single lens. Imparting the positive power to the first reflecting surface 14 allows for the back principal-point position to move to the side of the display device 20 with the result that the optical path taken grows long. This is preferable because the display screen is located externally of the field of view so that the outside is not cut off by the display screen. Giving the positive power to the first reflecting surface 14 is also preferable for correction of decentration aberrations occurring when the negative power is made strong to fit the combined reflecting and exit surface 11, 13 to the face.

Reference is then made to the prism configuration formed on the plane of symmetry SS by the combined reflecting and exit surface 11, 13 and the first reflecting surface 14 in the eyepiece projection optical system 1 according to the embodiment described here. That prism configuration is designed such that M (as defined just below) decreases substantially from the side of the display device 20 to the side of the third reflecting surface 12. Note that M is defined as distances between two points where, on the plane of symmetry SS, a straight line orthogonal to a segment PQ intersects the surfaces of the prism optical system 10 including the combined reflecting and exit surface 11, 13 and first reflecting surface 14.

As the prism optical system 10 takes a thin and long form as described herein, it is likely to give rise to a problem where unnecessary light other than normal light is likely to appear in the form of ghosts. With the instant condition satisfied, the sectional shape of the prism on the plane of symmetry is such that the distance between the combined reflecting surface and exit surface 11, 13 and the first reflecting surface 14 tapers substantially from the display device 20 down to the exit surface 11. Ghosts having a strong intensity are induced by the fact that unnecessary NA adjacent to NA exiting out from a panel as normal light propagates in the prism optical system 10 while reflected in a number of reflections that is less or more than the normal light and arrives at the viewer's eyeball.

The substantially tapering configuration as contemplated herein is thus preferable because the unnecessary light differs from the normal light in terms of exit angle and escapes outwardly. The instant arrangement works effectively for removal of ghosts appearing on both sides of the normal image.

Further, the eyepiece projection optical apparatus 1 according to one embodiment satisfies the following condition (4):

0.3<Mmin/Mmax<0.95 (4)

where Mmax is the maximum of the distances M.

Satisfaction of Condition (4) works more effectively for removal of ghosts. Exceeding the upper limit to Condition (4) makes it impossible to let the unnecessary NA escape, possibly resulting in the appearance of ghosts. Falling short of the lower limit to Condition (4) makes the portion of the prism optical system 10 on the display device 20 side thicker than required.

Preferably, the following condition (4′) should be satisfied:

0.4<Mmin/Mmax<0.9 (4′)

More preferably, the following condition (4″) should be satisfied:

0.5<Mmin/Mmax<0.85 (4″)

The eyepiece projection optical apparatus 1 according to the embodiment described here is configured such that the distance My between both sides of the prism in a direction orthogonal to the plane of symmetry SS becomes short from the side of the display device 20 to the side of the third reflecting surface 12.

Although the top and bottom sides of the prism optical system 10 in the direction vertical to the viewer are each not any optical effective surface, they give rise to ghosts in the vertical direction of the normal image because unnecessary NA exiting out from the display screen is guided by reflection. If the portion of the prism optical system 10 between the top and bottom sides tapers substantially from the display device 20 down toward the exit surface 11, it is preferable because the unnecessary light escapes outwardly due to a relative exit angle difference resulting from more reflections.

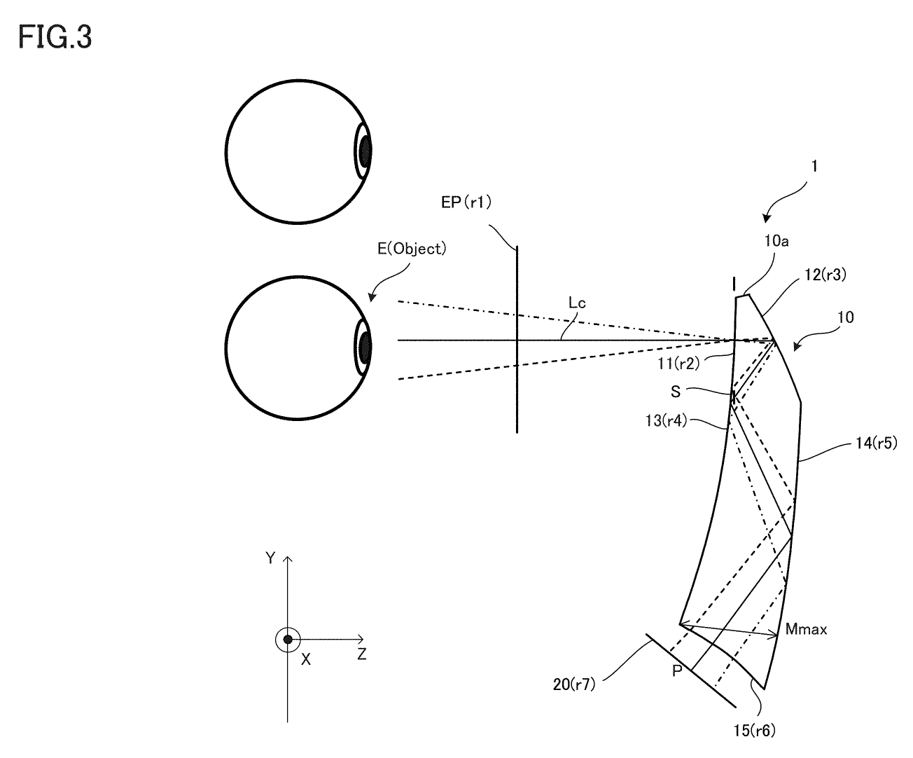

FIG. 3 is illustrative of the chamfered or beveled portion 10a of the prism optical system 10 according to one embodiment.

In the eyepiece projection optical apparatus 1 according to this embodiment, the chamfered portion 10a is provided to the end of the prism optical system 10 where the distance between the combined reflecting and exit surface 11, 13 and the third reflecting surface 12 becomes shortest on the plane of symmetry SS.

The extreme end of the prism optical system 10 where the combined reflecting and exit surface 11, 13 having an extended effective diameter intersects the third reflecting surface 1 has an acute shape and, hence, works an optical trap likely to receive unnecessary light, giving rise to ghosts. If that extreme end is chamfered off, it is preferable because light arriving at the extreme end is let go outwardly. More preferably, the end face is applied with an absorber or the like.

In the eyepiece projection optical apparatus 1 according to the embodiment described here, the first reflecting surface 14 satisfies the following condition (5) under which there is total reflection occurring on the plane of symmetry SS of a chief ray of visible light rays incident from the incident surface 15 and coming from the display screen.

np>(1/sin θc) (5)

where θc is an angle of incidence of visible light rays incident from the incident surface 15 and coming from the display screen on the first reflecting surface 14, and np is an refractive index of the prism optical system 10.

For the purpose of carrying out light guidance by total reflection with no loss of light quantity, it is desired for reflection of light off the first reflecting surface 14 to satisfy the total reflection requirement.

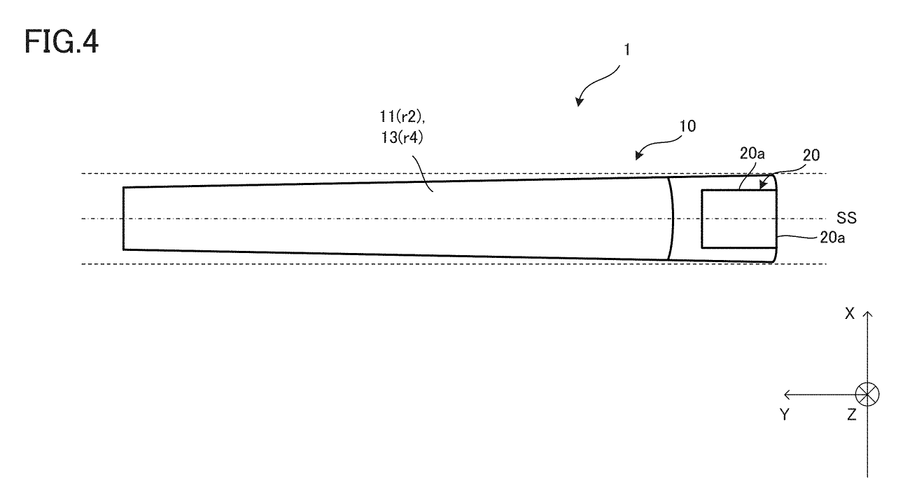

FIG. 4 is illustrative of the prism optical system 10 and display screen of the eyepiece projection optical apparatus 1 according to one embodiment.

In the eyepiece projection optical apparatus 1 according to this embodiment, the display device 20 includes a rectangular display screen having a long side 20a and a short side 20b, and the short side 20b is located in such a way as to intersect the plane of symmetry SS. The display device 20 shows vertical-direction images in the short side 20b direction.

This arrangement may provide oblong images to the viewer, and has an additional see-through effect that is preferable for taking hold of the viewing angle of view where the portion of the combined reflecting and exit surface 11, 13 (in the direction vertical to the eye line) becomes thinner than the pupil diameter.

Examples of one embodiment according to the invention are now explained.

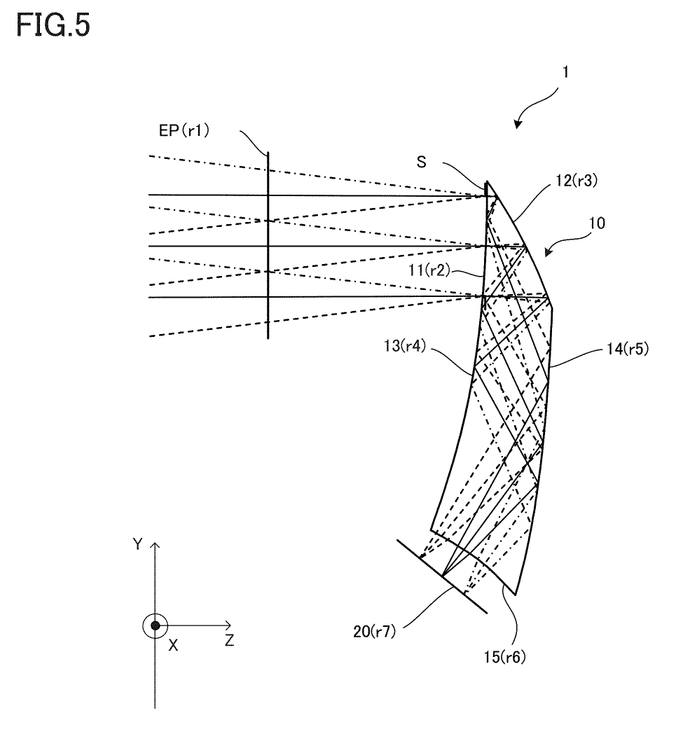

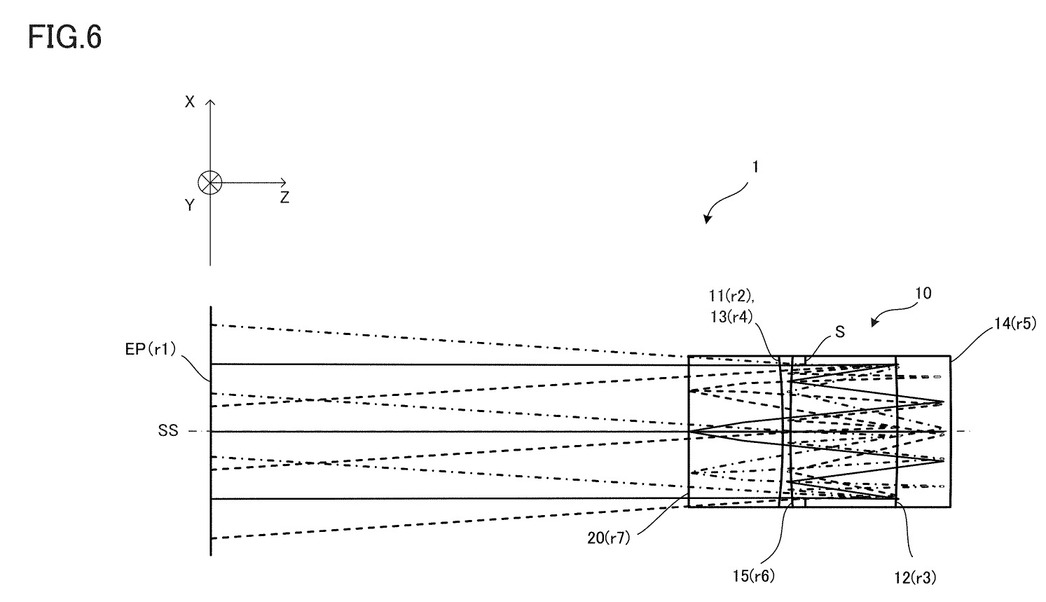

FIG. 5 is an optical path diagram taken in the Y-Z section of the eyepiece projection optical apparatus according to Example 1 of one embodiment, and FIG. 6 is an optical path diagram taken in the X-Z section of the eyepiece projection optical apparatus according to Example 1 of one embodiment.

The eyepiece projection optical apparatus 1 of Example 1 includes a display device 20 including a display screen for showing an image, and a prism optical system 10 for guiding an image shown on the display screen, with no formation of any intermediate image, into the viewer's eyeball where it is enlarged as a virtual image for projection. The prism optical system 10 is configured mirror-asymmetrically with respect to one plane of symmetry in an effective optical path. More specifically, the prism optical system 10 includes an incident surface 15 on which a light beam is incident, a first reflecting surface 14 that reflects the light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface 11, 13 where one area of the second reflecting surface 13 overlaps with one area of the exit surface 11.

The incident surface 15, first reflecting surface 14, second reflecting surface 13, third reflecting surface 12 and exit surface 11 are each defined by a free-form surface working as the rotationally asymmetric surface.

In back ray tracing, light exiting out from an object plane working as a virtual viewer's pupil passes through a virtual exit pupil EP, and transmits through the incident surface 15 before being incident on the prism optical system 10. The light incident from the incident surface 15 is internally reflected off the second reflecting surface 13 and third reflecting surface 12, respectively. The light reflected within the third reflecting surface 12 exits out from the prism optical system 10 through the exit surface 11. The light exiting out from the prism optical system 10 enters the display device 20 that is an image plane.

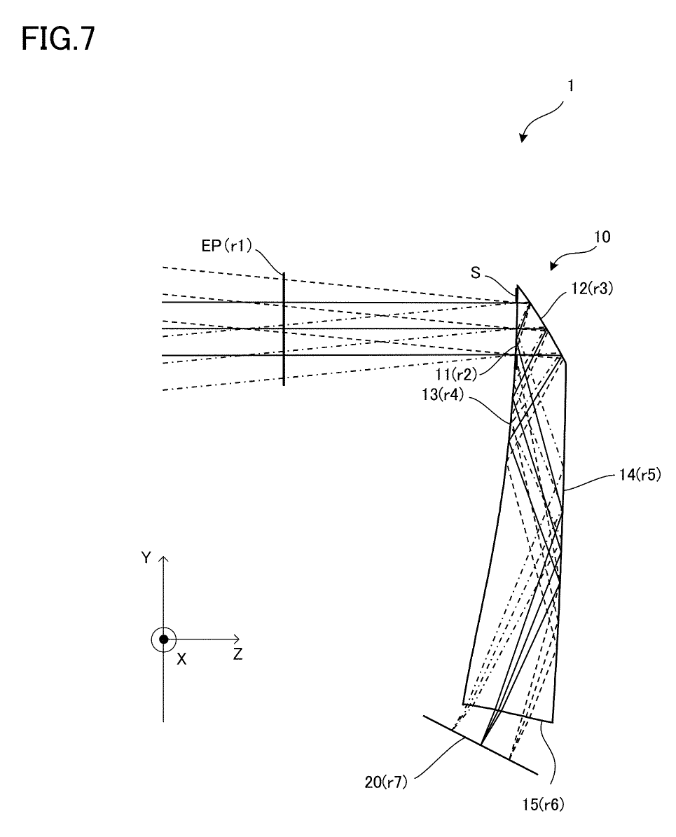

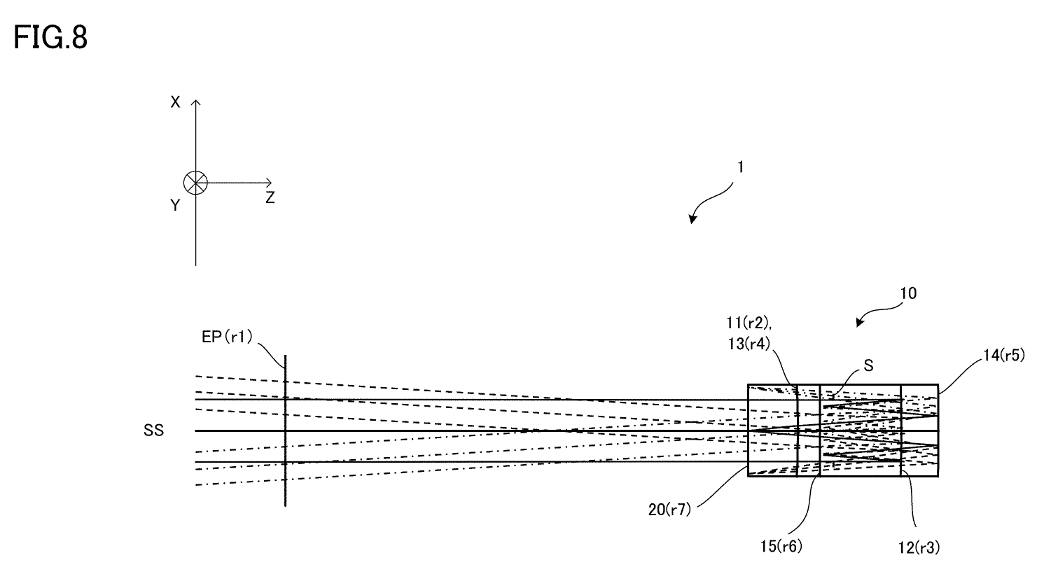

FIG. 7 is an optical path diagram taken in the Y-Z section of the eyepiece projection optical apparatus 1 according to Example 2 of one embodiment, and FIG. 8 is an optical path diagram taken in the X-Z section of the eyepiece projection optical apparatus 1 according to Example 2 of one embodiment.

The eyepiece projection optical apparatus 1 of Example 2 includes a display device 20 including a display screen for showing an image, and a prism optical system 10 for guiding an image shown on the display screen, with no formation of any intermediate image, into the viewer's eyeball where it is enlarged as a virtual image for projection. The prism optical system 10 is configured mirror-asymmetrically with respect to one plane of symmetry in an effective optical path. More specifically, the prism optical system 10 includes an incident surface 15 on which a light beam is incident, a first reflecting surface 14 that reflects the light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface 11, 13 where one area of the second reflecting surface 13 overlaps with one area of the exit surface 11.

The incident surface 15, first reflecting surface 14, second reflecting surface 13, third reflecting surface 12 and exit surface 11 are each defined by a free-form surface working as the rotationally asymmetric surface.

In back ray tracing, light exiting out from an object plane working as a virtual viewer's pupil passes through a virtual exit pupil EP, and transmits through the incident surface 15 before being incident on the prism optical system 10. The light incident from the incident surface 15 is internally reflected off the first reflecting surface 14, second reflecting surface 13 and third reflecting surface 12, respectively. The light reflected within the third reflecting surface 12 exits out from the prism optical system 10 through the exit surface 11. The light exiting out from the prism optical system 10 enters the display device 20 that is an image plane.

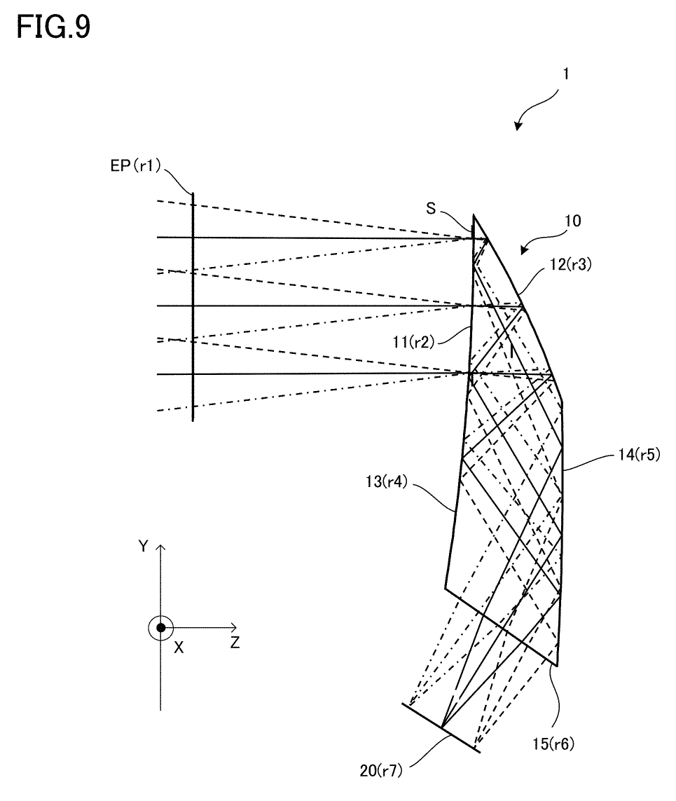

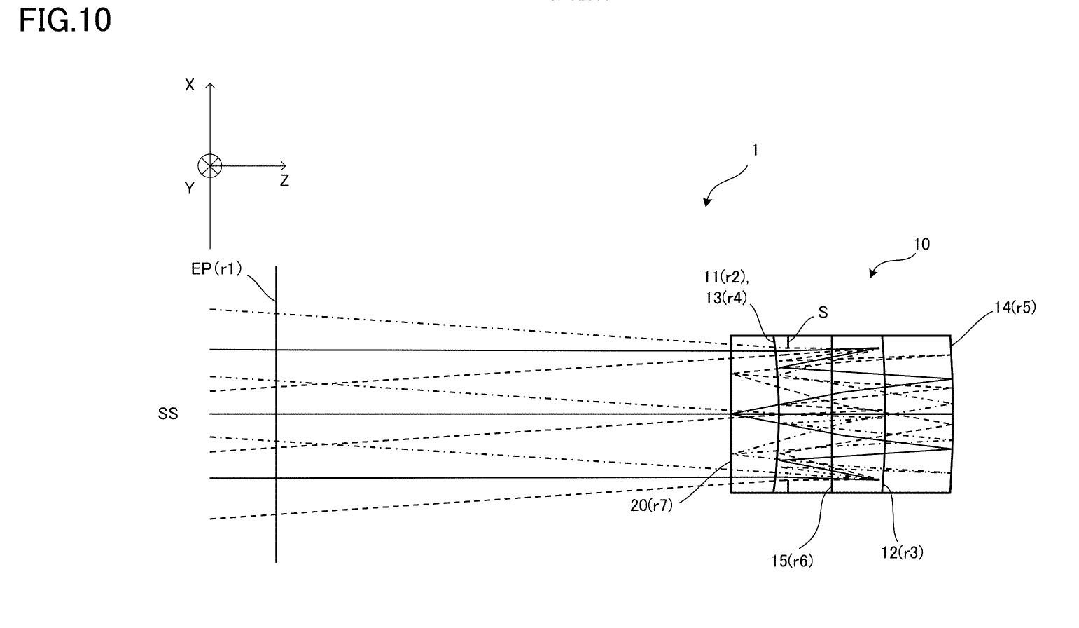

FIG. 9 is an optical path diagram taken in the Y-Z section of the eyepiece projection optical apparatus 1 according to Example 2 of one embodiment, and FIG. 10 is an optical path diagram taken in the X-Z section of the eyepiece projection optical apparatus 1 according to Example 3 of one embodiment.

The eyepiece projection optical apparatus 1 of Example 3 includes a display device 20 including a display screen for showing an image, and a prism optical system 10 for guiding an image shown on the display screen, with no formation of any intermediate image, into the viewer's eyeball where it is enlarged as a virtual image for projection. The prism optical system 10 is configured mirror-asymmetrically with respect to one plane of symmetry in an effective optical path. More specifically, the prism optical system 10 includes an incident surface 15 on which a light beam is incident, a first reflecting surface 14 that reflects the light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface 11, 13 where one area of the second reflecting surface 13 overlaps with one area of the exit surface 11.

The first reflecting surface 14, second reflecting surface 13, third reflecting surface 12 and exit surface 11 are each defined by a free-form surface working as the rotationally asymmetric surface (only the plane of symmetry of the prism optical system is defined as only the plane of symmetry of the surface). Note here that the incident surface 15 is defined by a plane and the third reflecting surface is defined by a toric surface.

In back ray tracing, light exiting out from an object plane working as a virtual viewer's pupil passes through a virtual exit pupil EP, and transmits through the incident surface 15 before being incident on the prism optical system 10. The light incident from the incident surface 15 is internally reflected off the first reflecting surface 14, second reflecting surface 13 and third reflecting surface 12, respectively. The light reflected within the third reflecting surface 12 exits out from the prism optical system 10 through the exit surface 11. The light exiting out from the prism optical system 10 enters the display device 20 that is an image plane.

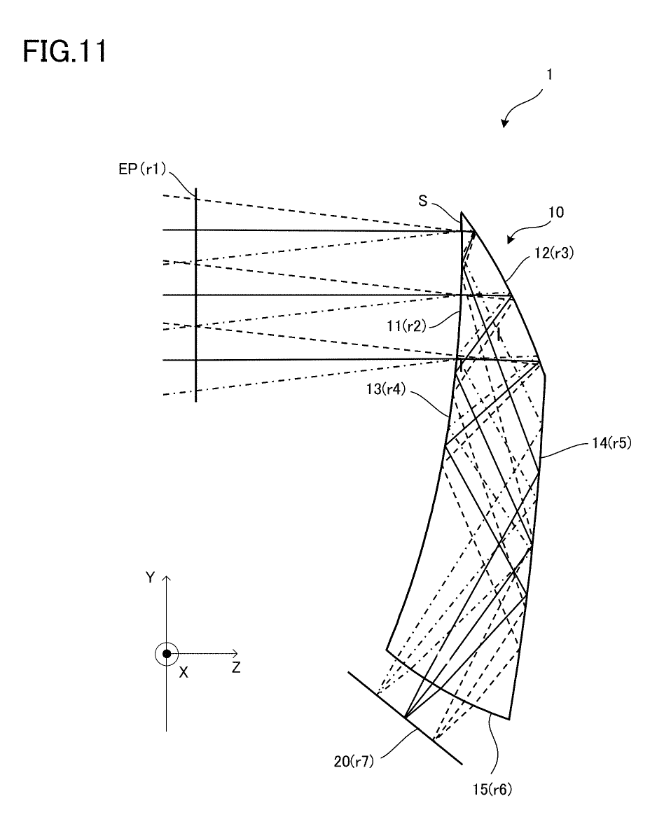

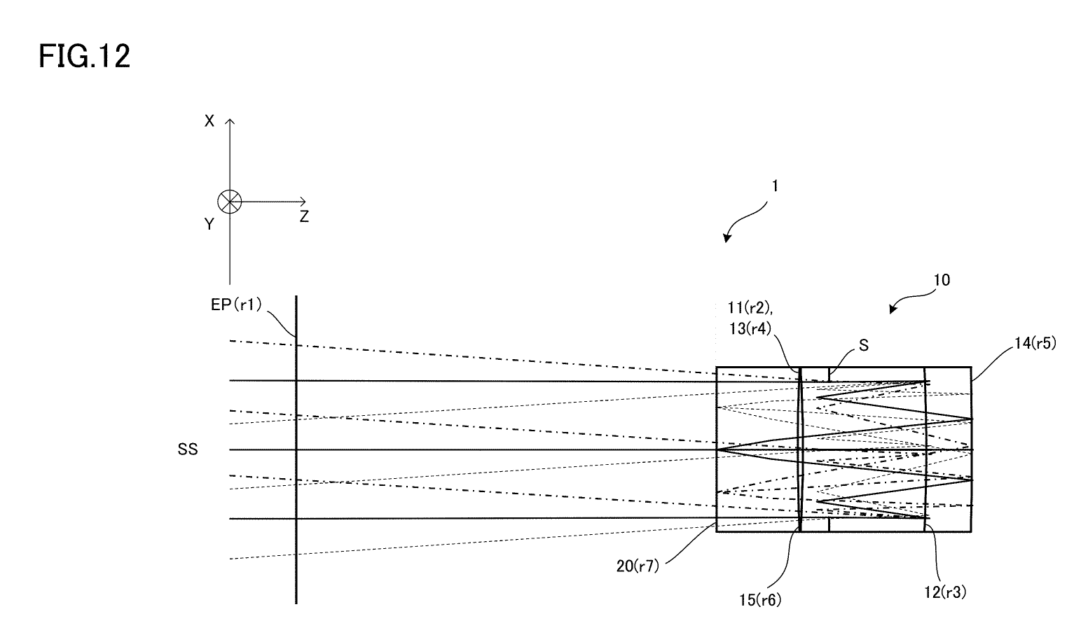

FIG. 11 is an optical path diagram taken in the Y-Z section of the eyepiece projection optical apparatus 1 according to Example 4 of one embodiment, and FIG. 12 is an optical path diagram taken in the X-Z section of the eyepiece projection optical apparatus 1 according to Example 4 of one embodiment.

The eyepiece projection optical apparatus 1 of Example 4 includes a display device 20 including a display screen for showing an image, and a prism optical system 10 for guiding an image shown on the display screen, with no formation of any intermediate image, into the viewer's eyeball where it is enlarged as a virtual image for projection. The prism optical system 10 is configured mirror-asymmetrically with respect to one plane of symmetry SS in an effective optical path. More specifically, the prism optical system 10 includes an incident surface 15 on which a light beam is incident, a first reflecting surface 14 that reflects the light beam incident from the incident surface 15, a third reflecting surface 12 that reflects a light beam toward an exit side and has a concave surface shape, a second reflecting surface 13 that is located in opposition to the first reflecting surface 14 and third reflecting surface 12 and reflects a light beam reflected off the first reflecting surface 14 toward the third reflecting surface 12, and an exit surface 11 through which the light reflected off the third reflecting surface 12 exits out, and further includes a combined reflecting and exit surface 11, 13 where one area of the second reflecting surface 13 overlaps with one area of the exit surface 11.

The second reflecting surface 13, third reflecting surface 12 and exit surface 11 are each defined by a free-form surface working as the rotationally asymmetric surface (only the plane of symmetry of the prism optical system is defined as only the plane of symmetry of the surface). Note here that the incident surface 15 and the first reflecting surface 14 are each defined by a spherical surface.

In back ray tracing, light exiting out from an object plane working as a virtual viewer's pupil passes through a virtual exit pupil EP, and transmits through the incident surface 15 before being incident on the prism optical system 10. The light incident from the incident surface 15 is internally reflected off the first reflecting surface 14, second reflecting surface 13 and third reflecting surface 12, respectively. The light reflected within the third reflecting surface 12 exits out from the prism optical system 10 through the exit surface 11. The light exiting out from the prism optical system 10 enters the display device 20 that is an image plane.

The eyepiece projection optical apparatus 1 according to one embodiment described here is now explained with reference to the examples.

The setup parameters of these optical systems will be described later. Suppose here that as shown typically in FIG. 1, a position (pupil position) E where the viewer takes a look at mages is defined as the dummy plane of the prism optical system 10. These parameters are based on the results of back ray tracing wherein light rays passing through the dummy plane travel through the prism optical system 10 toward the image display device 20.

Referring to the coordinate system here, as depicted in FIG. 1, the point O of intersection of the dummy plane (eye point EP) with the center chief ray CL is defined as the optical origin O of the decentered optical surface of a decentered optical system. Then, a direction of the center chief ray CL from the origin O toward the prism optical system 10 side is defined as the Z-axis positive direction; the direction orthogonal to the Z-axis from the origin O on the opposite side of the image display device 20 is defined as the Y-axis positive direction; and the sheet plane of FIG. 1 is defined as the Y-Z plane. Then, an axis that forms a right-handed orthogonal coordinate system with the Y- and Z-axes is defined as the X-axis positive direction.

Given to each decentered surface are the amount of decentration of the coordinate system, on which that surface is defined, from the center of the origin (eye point EP) of the optical system (X, Y and Z in the X-, Y- and Z-axis directions) and the angles (α, β, γ(°)) of tilt of the coordinate system for defining each surface about the X-, Y- and Z-axes of the coordinate system defined on the origin of the optical system. In that case, the positive α and β mean counterclockwise rotation with respect to the positive directions of the respective axes, and the positive γ means clockwise rotation with respect to the positive direction of the Z-axis. The exit surface 11 is defined by a curved surface that is designed as an exit pupil position where typical three chief rays intersect at one point, as shown.

When a specific surface of the optical function surfaces forming the optical system of each example and the subsequent surface form together a coaxial optical system, there is a surface separation given. Besides, the radii of curvature of the surfaces, and the refractive indices and Abbe constants of the media are given as usual.

It is also noted that coefficient terms to which no data are given in the following setup parameters are zero. The refractive indices and Abbe constants on a d-line basis (587.56 nm wavelength) are given, and length is given in mm. The decentration of each surface is represented by the quantity of decentration from the reference surface, as mentioned above.

The surface shape of the free-form surface used in the embodiments is defined by the following formula (a). Note here that the Z-axis in that defining formula stands for the axis of the free-form surface.

$$Z = ( {r}^{2} \text{/} R ) [ 1 + √ \{ 1 - ( 1 + k ) {( r \text{/} R )}^{2} \} ] ∞ + {Σ}_{j = 1} {C}_{j} {X}^{m} {Y}^{n} \qquad ( a )$$

Here the first term of Formula (a) is the spherical term, and the second term is the free-form surface term.

In the spherical term,

R is the radius of curvature of the apex,

k is the conic constant, and

r is √(X²+Y²).

The free-form surface term is:

$$∞ {Σ}_{j = 1} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7} . . . . .$$

where Cⱼ is a coefficient (j is an integer greater than 1).

Generally, although the free-form surface has not possibly a plane of symmetry in both the X-Z and Y-Z planes, yet it will have only one plane of symmetry parallel with the Y-Z plane by reducing all the odd-numbered terms for X down to zero. For instance, this may be achieved by reducing the coefficients C₂, C₅, C₇, C₉, C₁₂, C₁₄, C₁₆, C₁₈, C₂₀, C₂₃, C₂₅, C₂₇, C₂₉, C₃₁, C₃₃, C₃₅ . . . in the defining formula (a) down to zero.

Also, by reducing all the odd-numbered terms for Y down to zero, for instance, by reducing C₃, C₅, C₈, C₁₀, C₁₂, C₁₄, C₁₇, C₁₉, C₂₁, C₂₃, C₂₅, C₂₇, C₃₀, C₃₂, C₃₄, C₃₆ . . . in the defining formula down to zero, the free-form surface will have only one plane of symmetry parallel with the X-Z plane.

If the optical system is decentered in any one direction of the planes of symmetry, for instance, the Y-axis direction with respect to the plane of symmetry parallel with the Y-Z plane, and the X-axis direction with respect to the plane of symmetry parallel with the X-Z plane, it is then possible to improve assembling capability while making effective correction for rotationally asymmetric aberrations occurring from decentration.

It is here to be noted that the defining formula (a) is provided for the purpose of illustration alone. The free-form surface has a feature of using a rotationally asymmetric surface thereby making correction for rotationally asymmetric aberrations occurring from decentration while, at the same time, improving assembling capabilities. As a matter of course, the same effect is achievable for any other defining formula too.

In what follows, the setup parameters of Examples 1 to 4 will be given. Note here that the “FFS” in the following tables stands for the free-form surface, and that the symbol “e” indicates that the numerical value subsequent to it is a power exponent with 10 as a base; for instance “1.0e-5” stands for “1.0×10⁻⁵”.

### Example 1

| Surface | Radius of | Surface | | Refractive | Abbe |
|---|---|---|---|---|---|
| No. | Curvature | Separation | Decentration | Index | Constant |
| Object | ∞ | −1000.00 | | | |
| Surface | | | | | |
| r1 | ∞ (Viewer's Pupil) | 18.00 | | | |
| r2 | FFS[1] (Exit Pupil) | 0.00 | Decentration(1) | 1.544 | 56 |
| r3 | FFS[2] | 0.00 | Decentration(2) | 1.544 | 56 |
| r4 | FFS[1] | 0.00 | Decentration(1) | 1.544 | 56 |
| r5 | FFS[3] | 0.00 | Decentration(3) | 1.544 | 56 |
| r6 | FFS[4] | 0.00 | Decentration(4) | 1.544 | 56 |
| Image | ∞ | 0.00 | Decentration(5) | | |
| Plane | | | | | |

FFS[1]

| | | | | | |
|---|---|---|---|---|---|
| C4 | −8.12e−03 | C6 | −4.34e−03 | C8 | 4.07e−04 |
| C10 | 2.31e−05 | C11 | 3.74e−05 | C13 | −1.78e−05 |
| C15 | −5.28e−06 | C17 | −1.73e−05 | C19 | −1.92e−06 |
| C21 | −6.50e−08 | C22 | −2.91e−06 | C24 | −2.98e−07 |
| C26 | −1.17e−07 | C28 | 2.69e−09 | | |

FFS[2]

| | | | | | |
|---|---|---|---|---|---|
| C4 | −1.12e−02 | C6 | −1.20e−02 | C8 | 2.89e−04 |
| C10 | −2.11e−04 | C11 | 2.54e−06 | C13 | 9.90e−06 |
| C15 | −1.77e−05 | C17 | −2.60e−06 | C19 | 5.75e−07 |
| C21 | −4.44e−07 | | | | |

FFS[3]

| | | | | | |
|---|---|---|---|---|---|
| C4 | −3.13e−03 | C6 | −3.13e−03 | C8 | 3.83e−06 |
| C10 | 7.18e−05 | C11 | 2.04e−05 | C13 | −9.22e−06 |
| C15 | −3.11e−06 | C17 | −1.09e−05 | C19 | −9.73e−07 |
| C21 | 7.86e−08 | C22 | 3.75e−06 | C24 | 2.94e−06 |
| C26 | −1.37e−07 | C28 | 3.65e−09 | | |

FFS[4]

| | | | | | |
|---|---|---|---|---|---|
| C4 | 2.82e−02 | C6 | −3.32e−02 | C8 | 7.42e−04 |
| C10 | 1.77e−03 | C11 | 7.24e−04 | C13 | −2.85e−04 |
| C15 | 5.28e−04 | C17 | −2.7e−04 | C19 | −5.76e−06 |
| C21 | −7.10e−05 | | | | |

Decentration[1]

| | | | | | |
|---|---|---|---|---|---|
| X | 0.00 | Y | 0.00 | Z | 18.00 |
| α | −2.45 | β | 0.00 | γ | 0.00 |

Decentration[2]

| | | | | | |
|---|---|---|---|---|---|
| X | 0.00 | Y | 4.97 | Z | 18.55 |
| α | 34.05 | β | 0.00 | γ | 0.00 |

Decentration[3]

| | | | | | |
|---|---|---|---|---|---|
| X | 0.00 | Y | −14.19 | Z | 23.23 |
| α | −4.78 | β | 0.00 | γ | 0.00 |

Decentration[4]

| | | | | | |
|---|---|---|---|---|---|
| X | 0.00 | Y | −27.09 | Z | 17.43 |
| α | 52.66 | β | 0.00 | γ | 0.00 |

Decentration[5]

| | | | | | |
|---|---|---|---|---|---|
| X | 0.00 | Y | −28.50 | Z | 14.2 |
| α | 51.00 | β | 0.00 | γ | 0.00 |

The exit pupil's effective diameter is 4.5 mm in the X-direction and 8.6 mm in the Y-direction.

The X-direction angle of view is 7.4°.

The Y-direction angle of view of 13.1°.

### Example 2

| Surface | Radius of | Surface | | Refractive | Abbe |
|---|---|---|---|---|---|
| No. | Curvature | Separation | Decentration | Index | Constant |
| Object | ∞ | −1000.00 | | | |
| Surface | | | | | |
| r1 | ∞ (Viewer's Pupil) | 18.00 | | | |
| r2 | FFS[1] (Exit Pupil) | 0.00 | Decentration(1) | 1.544 | 56 |
| r3 | FFS[2] | 0.00 | Decentration(2) | 1.544 | 56 |
| r4 | FFS[1] | 0.00 | Decentration(1) | 1.544 | 56 |
| r5 | FFS[3] | 0.00 | Decentration(3) | 1.544 | 56 |
| r6 | FFS[4] | 0.00 | Decentration(4) | 1.544 | 56 |
| Image | ∞ | 0.00 | Decentration(5) | | |
| Plane | | | | | |

FFS[1]

| | | | | | |
|---|---|---|---|---|---|
| C4 | −7.74e−03 | C6 | −4.36e−03 | C8 | 4.81e−05 |
| C10 | −1.51e−04 | C11 | 1.07e−04 | C13 | −1.21e−04 |
| C15 | −1.65e−05 | C17 | −4.51e−05 | C19 | −1.68e−05 |
| C21 | −5.86e−07 | C22 | −3.44e−06 | C24 | −2.06e−06 |
| C26 | −8.53e−07 | C28 | −5.84e−09 | | |

FFS[2]

| | | | | | |
|---|---|---|---|---|---|
| C4 | −1.18e−02 | C6 | −1.30e−02 | C8 | 6.90e−05 |
| C10 | −5.40e−04 | C11 | −4.35e−05 | C13 | −2.36e−05 |
| C15 | −7.86e−05 | C17 | −1.15e−05 | C19 | −8.92e−07 |
| C21 | −5.01e−06 | | | | |

FFS[3]

| | | | | | |
|---|---|---|---|---|---|
| C4 | −2.71e−03 | C6 | −1.16e−03 | C8 | 1.75e−04 |
| C10 | 1.11e−05 | C11 | 4.92e−04 | C13 | −7.49e−05 |
| C15 | 6.62e−07 | C17 | −1.13e−04 | C19 | 9.49e−06 |
| C21 | 4.85e−09 | C22 | 8.00e−06 | C24 | 5.99e−06 |
| C26 | −4.06e−07 | C28 | −1.93e−09 | | |

FFS[4]

| | | | | | |
|---|---|---|---|---|---|
| C4 | 1.09e−02 | C6 | 9.55e−03 | C8 | 1.23e−03 |
| C10 | −1.76e−04 | C11 | 1.89e−03 | C13 | −8.50e−04 |
| C15 | −5.65e−04 | C17 | −5.76e−04 | C19 | 7.43e−05 |
| C21 | 4.36e−05 | | | | |

Decentration[1]

| | | | | | |
|---|---|---|---|---|---|
| X | 0.00 | Y | 0.00 | Z | 18.00 |
| α | −2.11 | β | 0.00 | γ | 0.00 |

Decentration[2]

| | | | | | |
|---|---|---|---|---|---|
| X | 0.00 | Y | 1.81 | Z | 19.15 |
| α | 34.32 | β | 0.00 | γ | 0.00 |

Decentration[3]

| | | | | | |
|---|---|---|---|---|---|
| X | 0.00 | Y | −23.00 | Z | 21.19 |
| α | −2.82 | β | 0.00 | γ | 0.00 |

Decentration[4]

| | | | | | |
|---|---|---|---|---|---|
| X | 0.00 | Y | −30.00 | Z | 19.50 |
| α | 77.96 | β | 0.00 | γ | 0.00 |

Decentration[5]

| | | | | | |
|---|---|---|---|---|---|
| X | 0.00 | Y | −32.00 | Z | 15.2 |
| α | 62.00 | β | 0.00 | γ | 0.00 |

The exit pupil's effective diameter is 2.0 mm in the X-direction and 4.0 mm in the Y-direction.

The X-direction angle of view is 6.9°.

The Y-direction angle of view of 11.0°.

### Example 3

| Surface | Radius of | Surface | | Refractive | Abbe |
|---|---|---|---|---|---|
| No. | Curvature | Separation | Decentration | Index | Constant |
| Object | ∞ | −1000.00 | | | |
| Surface | | | | | |
| r1 | ∞ (Viewer's Pupil) | 18.00 | | | |
| r2 | FFS[1] (Exit Pupil) | 0.00 | Decentration(1) | 1.544 | 56 |
| r3 | Toric Surface | 0.00 | Decentration(2) | 1.544 | 56 |
| r4 | FFS[1] | 0.00 | Decentration(1) | 1.544 | 56 |
| r5 | FFS[3] | 0.00 | Decentration(3) | 1.544 | 56 |
| r6 | ∞ | 0.00 | Decentration(4) | 1.544 | 56 |
| Image | ∞ | 0.00 | Decentration(5) | | |
| Plane | | | | | |

FFS[1]

| | | | | | |
|---|---|---|---|---|---|
| C4 | −2.14e−02 | C6 | −3.21e−03 | C8 | 4.16e−04 |
| C10 | 1.72e−05 | C11 | −1.54e−05 | C13 | −1.21e−05 |
| C15 | 4.10e−07 | | | | |

FFS[3]

| | | | | | |
|---|---|---|---|---|---|
| C4 | −1.33e−02 | C6 | −2.50e−03 | C8 | 3.24e−04 |
| C10 | 9.95e−06 | C11 | −2.45e−05 | C13 | −7.66e−06 |
| C15 | −1.14e−08 | C17 | 1.12e−06 | C19 | −1.23e−07 |
| C21 | 3.31e−09 | | | | |

Toric Surface

RX = −27.246
RY = −55.891

Decentration[1]

| | | | | | |
|---|---|---|---|---|---|
| X | 0.00 | Y | 0.00 | Z | 18.00 |
| α | −2.02 | β | 0.00 | γ | 0.00 |

Decentration[2]

| | | | | | |
|---|---|---|---|---|---|
| X | 0.00 | Y | 2.39 | Z | 20.07 |
| α | 28.36 | β | 0.00 | γ | 0.00 |

Decentration[3]

| | | | | | |
|---|---|---|---|---|---|
| X | 0.00 | Y | −18.76 | Z | 23.69 |
| α | −2.19 | β | 0.00 | γ | 0.00 |

Decentration[4]

| | | | | | |
|---|---|---|---|---|---|
| X | 0.00 | Y | −20.36 | Z | 19.55 |
| α | 55.60 | β | 0.00 | γ | 0.00 |

Decentration[5]

| | | | | | |
|---|---|---|---|---|---|
| X | 0.00 | Y | −26.99 | Z | 15.99 |
| α | 58.07 | β | 0.00 | γ | 0.00 |

The exit pupil's effective diameter is 4.5 mm in the X-direction and 8.6 mm in the Y-direction.

The X-direction angle of view is 7.4°.

The Y-direction angle of view of 13.1°.

### Example 4

| Surface | Radius of | Surface | | Refractive | Abbe |
|---|---|---|---|---|---|
| No. | Curvature | Separation | Decentration | Index | Constant |
| Object | ∞ | −1000.00 | | | |
| Surface | | | | | |
| r1 | ∞ (Viewer's Pupil) | 18.00 | | | |
| r2 | FFS[1] (Exit Pupil) | 0.00 | Decentration(l) | 1.544 | 56 |
| r3 | FFS[3] | 0.00 | Decentration(2) | 1.544 | 56 |
| r4 | FFS[1] | 0.00 | Decentration(1) | 1.544 | 56 |
| r5 | −187.734 | 0.00 | Decentration(3) | 1.544 | 56 |
| r6 | 25.250 | 0.00 | Decentration(4) | 1.544 | 56 |
| Image | ∞ | 0.00 | Decentration(5) | | |
| Plane | | | | | |

FFS[1]

| | | | | | |
|---|---|---|---|---|---|
| C4 | −6.31e−03 | C6 | −6.78e−03 | C8 | 3.40e−04 |
| C10 | −1.25e−04 | C11 | −2.11e−05 | C13 | −1.31e−05 |
| C15 | −8.44e−06 | C17 | −1.48e−05 | C19 | −3.06e−06 |
| C21 | −8.27e−08 | C22 | −1.71e−08 | C24 | −2.02e−06 |
| C26 | −2.27e−07 | C28 | 1.51e−09 | | |

FFS[2]

| | | | | | |
|---|---|---|---|---|---|
| C4 | −1.08e−02 | C6 | −1.52e−02 | C8 | 2.10e−04 |
| C10 | −5.21e−04 | C11 | −6.42e−06 | C13 | 3.97e−06 |
| C15 | −4.27e−05 | C17 | 5.34e−08 | C19 | 5.64e−07 |
| C21 | −1.36e−06 | | | | |

Decentration[1]

| | | | | | |
|---|---|---|---|---|---|
| X | 0.00 | Y | 0.00 | Z | 18.00 |
| α | −2.41 | β | 0.00 | γ | 0.00 |

Decentration[2]

| | | | | | |
|---|---|---|---|---|---|
| X | 0.00 | Y | 3.34 | Z | 19.57 |
| α | 32.14 | β | 0.00 | γ | 0.00 |

Decentration[3]

| | | | | | |
|---|---|---|---|---|---|
| X | 0.00 | Y | −14.22 | Z | 23.11 |
| α | −5.12 | β | 0.00 | γ | 0.00 |

Decentration[4]

| | | | | | |
|---|---|---|---|---|---|
| X | 0.00 | Y | −26.92 | Z | 17.38 |
| α | 61.99 | β | 0.00 | γ | 0.00 |

Decentration[5]

| | | | | | |
|---|---|---|---|---|---|
| X | 0.00 | Y | −28.52 | Z | 14.20 |
| α | 51.27 | β | 0.00 | γ | 0.00 |

The exit pupil's effective diameter is 4.5 mm in the X-direction and 8.6 mm in the Y-direction.

The X-direction angle of view is 7.4°.

The Y-direction angle of view of 13.1°.

Tabulated below are the values of the components and the values of Conditions (1) to (4) in the Examples 1 to 4.

TABLE 1

| | Ex. 1 | Ex. 2 | Ex. 3 | Ex. 4 |
|---|---|---|---|---|
| L | 34.4 | 35.4 | 32.8 | 34.3 |
| Mmin (Cond. 2) | 6.2 | 4.0 | 6.1 | 6.1 |
| Mmax | 8.7 | 7.0 | 7.5 | 9.0 |
| Mmin/L (Cond. 1) | 0.18 | 0.11 | 0.19 | 0.18 |
| Tv (Cond. 3) | 4.6 | 2.0 | 4.6 | 4.6 |
| Mmin/Mmax (Cond. 4) | 0.71 | 0.57 | 0.81 | 0.68 |

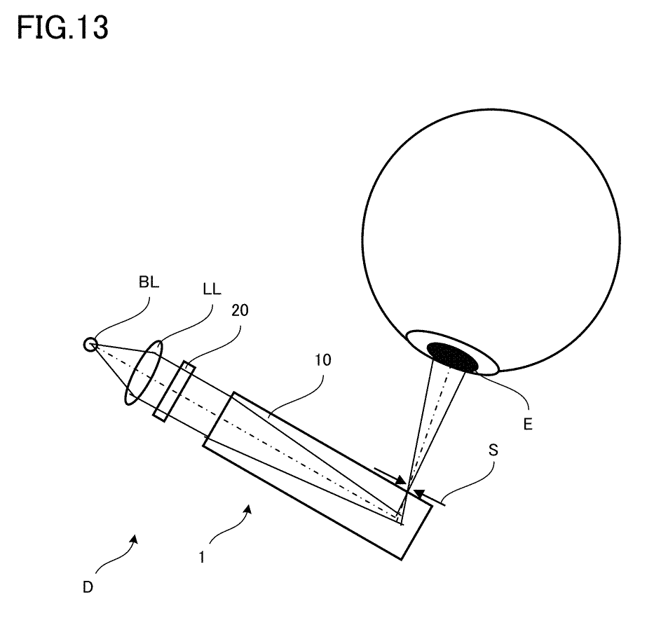

FIG. 13 shows an exemplary setup of the image display apparatus D incorporating the eyepiece projection apparatus 1.

By use of the prism optical system 10 and image display device 20, the image display apparatus D as described here can be reduced in terms of both size and weight, and allows the wearer to look objectively normal.

In the image display apparatus D as described here, a liquid crystal display device is used as the image display device 20 for which a backlight BL must be used as a light source. In the embodiment here, a lighting lens LL is interposed between the backlight BL and the image display device 20.

In the thus set-up image display apparatus D, image light exiting out of the image display device 20 is bent by the prism optical system 10 having a positive power toward the eyeballs, and allows the viewer to view images as virtual ones.

If the vicinity of an exit portion is allowed to function just like an aperture stop S, it is then possible to view images even when the prism itself is slimmed down.

Further, when the image display device 20 is of the liquid crystal type, the backlight BL is required, so it is desired in view of lighting efficiency that an image from the light source be positioned in the vicinity of an exit window. As a matter of course, any back light is not necessary for a light-emitting display device such as an OLED.

A center chief ray exiting out of the image display apparatus D may be positioned in such a way as to lie somewhat outside the frontal direction with respect to the eyeballs.

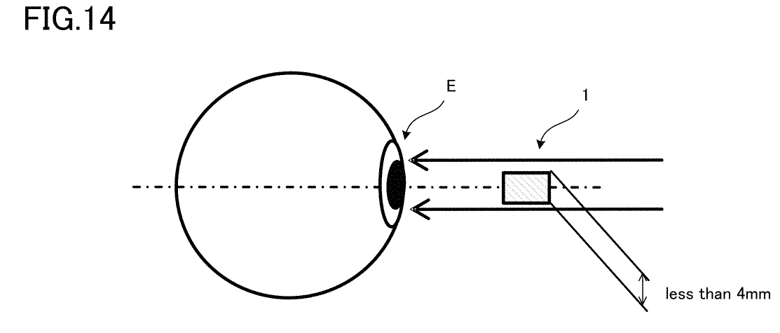

FIG. 14 is a side view of the image display apparatus D that incorporates the eyepiece projection apparatus 1.

As shown in FIG. 14, the width of a portion in the vertical direction of the prism optical system 10 of the eyepiece projection apparatus 1 in opposition to the pupil E of the viewer is set to less than 4 mm that is a human's average pupil diameter. It is then possible to cast scenes in the rear of the prism optical system 1 onto the pupil E of the viewer from above and below the prism optical system 10, that is, to obtain the see-through effect.

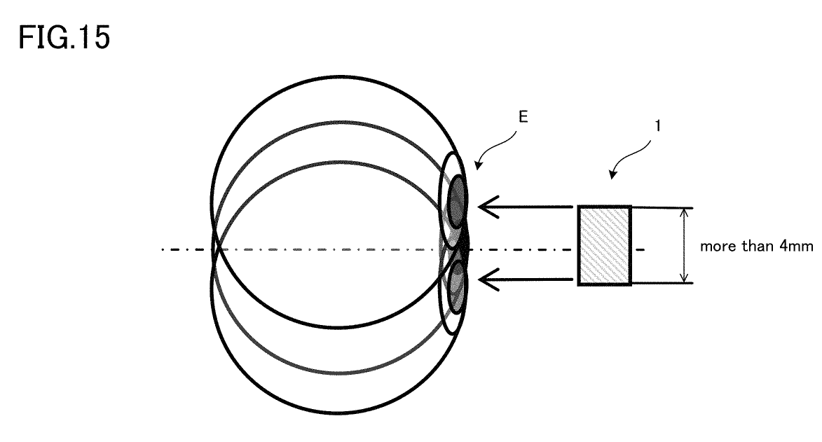

FIG. 15 is a side view of another example of the image display apparatus D that incorporates eyepiece projection apparatus 1.

As shown in FIG. 15, the width of a portion in the vertical direction of the prism optical system 10 of the eyepiece projection apparatus 1 in opposition to the pupil E of the viewer is set to greater than 4 mm. It is then possible to make use of an increased height thereby rendering tolerance for vertical shifting higher.

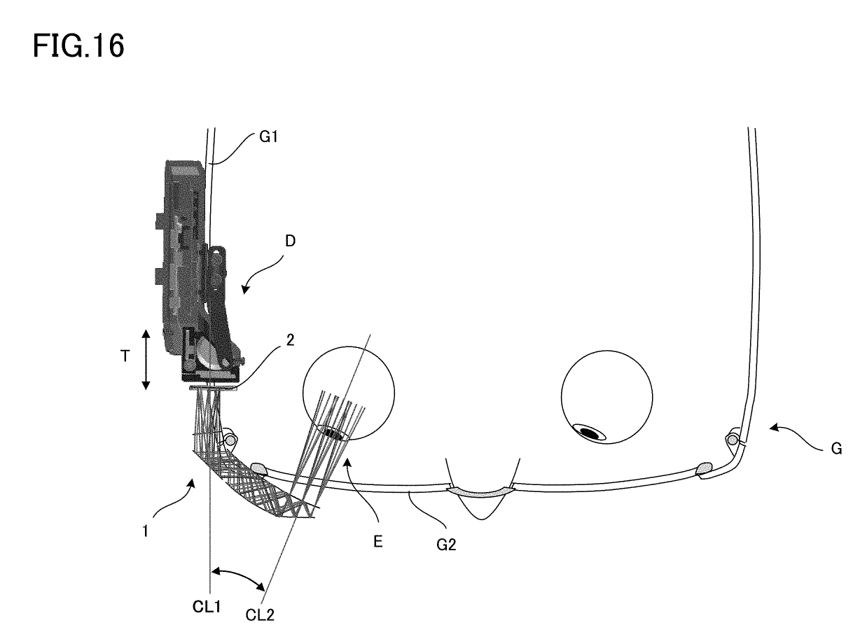

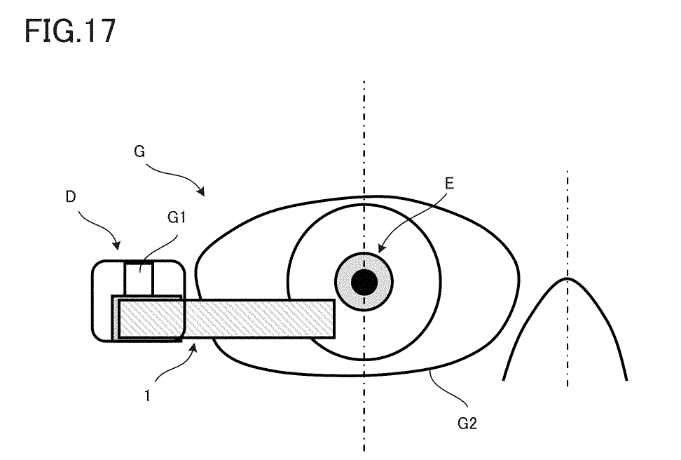

FIG. 16 is illustrative of a head-mounted type image display apparatus D that incorporates the eyepiece projection apparatus 1, and FIG. 17 is a front view of the head-mounted type image display apparatus D that incorporates the eyepiece projection apparatus 1.

The image display apparatus D here makes it possible to view an external world and electronic images at the same time without disturbing the field of view for external worlds (the see-through function) while it can be reduced in terms of both size and weight.

As shown in FIG. 16, the eyepiece projection apparatus 1 may be mounted on eyeglasses G. Image light exiting out of the frontally oriented image display device 20 is directed through the prism optical system 10 toward the pupil. The prism optical system 10 has a positive power enough to enlarge an image from the image display device 20 so that the wearer can view it as a virtual image. If the image display device 20 is moved back and forth along the direction (indicated by an arrow T) substantially along the temple portion G1, it is then possible to adjust it in conformity with the diopter of the viewer. Note here that the angle between the first center chief ray CL1 exiting out from the center of the image display device 20 and the second center chief ray CL2 exiting out from the prism and arriving at the center of the viewer's pupil is preferably 0° to 40°.

In the image display apparatus D of FIG. 1 as viewed from the front, the prism optical system 1 is located in opposition to the viewer's pupil E, as shown in FIG. 17, so that an enlarged virtual image can be presented to the viewer.

It is here to be appreciated that the invention is in no sense limited to such embodiments as described above. While the explanation of some embodiments embraces numerous specific details for illustration, it would be obvious to those skilled in the art that diverse variations or modifications made thereto are included within the scope of the invention. In other words, illustrative embodiments of the invention are described without excluding generality from the claimed inventions and imposing any limitation thereon.

### REFERENCE SIGNS LIST

1: Eyepiece Projection Apparatus
10: Prism Optical System
20: Image Display Device
D: Image Display Apparatus

1. An eyepiece projection apparatus comprising:
a display device including a display screen for showing an image, and
an eyepiece projection optical system that guides the image shown on the display screen, with no formation of any intermediate image, into a viewer's eyeball where it is enlarged as a virtual image for projection, wherein the eyepiece projection optical system includes a prism that is capable of three internal reflections in an effective optical path and filled up with a medium having a refractive index higher than that of an ambient medium, wherein the prism is configured mirror-symmetrically with respect to one plane of symmetry in an effective optical path and includes an incident surface on which a light beam is incident, a first reflecting surface that reflects the light beam incident from the incident surface, a third reflecting surface that reflects a light beam toward an exit side and has a concave surface shape, a second reflecting surface that is located in opposition to the first reflecting surface and third reflecting surface and reflects a light beam reflected off the first reflecting surface toward the third reflecting surface, and an exit surface through which the light reflected off the third reflecting surface exits out, and further includes a combined reflecting and exit surface where one area of the second reflecting surface overlaps with one area of the exit surface, with satisfaction of the following condition (1):
0.05<Mmin/L<0.23 (1)
where L is a distance on the plane of symmetry from a center point P of the display screen to a prism contour end Q that is farthest away from the center point P, and Mmin is the minimum of distances on the plane of symmetry between two points where a straight line orthogonal to a segment PQ intersects various surfaces inclusive of the combined reflecting and exit surface and the first reflecting surface of the prism.

2. The eyepiece projection apparatus according to claim 1, satisfying the following condition (2):
2.0 mm<Mmin<10.0 mm (2)

3. The eyepiece projection apparatus according to claim 1, satisfying the following condition (3):
1.5 mm<Tv<14.5 mm (3)
where Tv is the maximum width of the effective area of the third reflecting surface as measured in a direction vertical to the plane of symmetry.

4. The eyepiece projection apparatus according to claim 1,
wherein at least two of the incident surface, the first reflecting surface, the third reflecting surface and the combined reflecting and exit surface each has a rotationally asymmetric surface that is mirror symmetric with respect to the plane of symmetry.

5. The eyepiece projection apparatus according to claim 1,
wherein at least two of the incident surface, the first reflecting surface, the third reflecting surface and the combined reflecting and exit surface each has a rotationally asymmetric surface that is symmetric with respect to the plane of symmetry alone.

6. The eyepiece projection apparatus according to claim 1,
wherein the first reflecting surface, the third reflecting surface and the combined reflecting and exit surface each has a rotationally asymmetric surface that is mirror symmetric with respect to the plane of symmetry.

7. The eyepiece projection apparatus according to claim 1,
wherein the first reflecting surface, the third reflecting surface and the combined reflecting and exit surface each has a rotationally asymmetric surface that is symmetric with respect to the plane of symmetry alone.

8. The eyepiece projection apparatus according to claim 1,
wherein the incident surface, the first reflecting surface, the third reflecting surface and the combined reflecting and exit surface each has a rotationally asymmetric surface that is mirror symmetric with respect to the plane of symmetry.

9. The eyepiece projection apparatus according to claim 1,
wherein the incident surface, the first reflecting surface, the third reflecting surface and the combined reflecting and exit surface each has a rotationally asymmetric surface that is symmetric with respect to the plane of symmetry alone.

10. The eyepiece projection apparatus according to claim 1,
wherein the combined reflecting and exit surface has, on the plane of symmetry, a power enough negative to be concave on the side of the viewer's eyeball.

11. The eyepiece projection apparatus according to claim 1,
wherein the first reflecting surface has, on the plane of symmetry, a power enough positive to be concave on the side of the viewer's eyeball.

12. The eyepiece projection apparatus according to claim 1,
wherein a prism defined by the combined reflecting and exit surface and the first reflecting surface on the plane of symmetry is configured such that M becomes substantially short from the side of the display device toward the side of the third reflecting surface, wherein M stands for a distance between two points where, on the plane of symmetry, a straight line orthogonal to a segment PQ intersects the surfaces of the prism inclusive of the combined reflecting and exit surface and the first reflecting surface.

13. The eyepiece projection apparatus according to claim 1,
satisfying the following condition (4):
0.3<Mmin/Mmax<0.95 (4)
where Mmax is the maximum of the distances M.

14. The eyepiece projection apparatus according to claim 1,
wherein the prism is configured such that a distance between both sides of the prism in a direction orthogonal to the plane of symmetry becomes short from the side of the display device toward the side of the third reflecting surface.

15. The eyepiece projection apparatus according to claim 1,
wherein the prism includes a chamfered portion at an end of the prism where a distance between the combined reflecting and exit surface and the third reflecting surface becomes shortest.

16. The eyepiece projection apparatus according to claim 1,
wherein the first reflecting surface satisfies the following condition (5) under which there is total reflection on the plane of symmetry of a chief ray of visible light rays incident from the incident surface and coming from the display screen:
n(1/sin θc) (5)
where θc is an angle of incidence of visible light rays incident from the incident surface and coming from the display screen on the first reflecting surface, and np is an refractive index of the prism.

17. The eyepiece projection apparatus according to claim 1,
wherein the display device includes a rectangular display screen having a long side and a short side, wherein:
the short side is located while intersecting the plane of symmetry, and
the display device shows a vertical-direction image in a direction of the short side.
